(19) United States
(12) Patent Application Publication
(10) Pub. No.: US 2016/0058006 A1
(43) Pub. Date: Mar. 3, 2016

(54) COMPOSITIONS AND METHODS FOR ATTRACTING STINK BUGS

(71) Applicant: BEDOUKIAN RESEARCH, INC., Danbury, CT (US)

(72) Inventor: Robert H. BEDOUKIAN, West Redding, CT (US)

(21) Appl. No.: 14/835,200

(22) Filed: Aug. 25, 2015

Related U.S. Application Data
(60) Provisional application No. 62/041,689, filed on Aug. 26, 2014.

(51) Int. Cl. A01N 43/20; A01N 37/06; A01N 31/02

(52) U.S. Cl. CPC A01N 43/20; A01N 31/02; A01N 37/06

(57) ABSTRACT

Compositions and methods are provided for attracting stink bugs (e.g., Halyomorpha halys). The compositions include at least one pheromone and at least one synergist. The synergist/attractant is preferably at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof. The pheromone is preferably murgantiol. This disclosure provides traps containing the composition for attracting stink bugs, and methods for attracting, capturing, killing or sterilizing stink bugs using the composition.

### RELATED APPLICATION

This application claims the benefit of copending U.S. Application No. 62/041,689, filed Aug. 26, 2014, which is incorporated herein by reference in its entirety.

### BACKGROUND OF THE DISCLOSURE

1. Field of the Disclosure

This disclosure relates to compositions and methods for attracting stink bugs, in particular, brown marmorated stink bugs, Halyomorpha halys.

2. Description of the Related Art

Stink bugs are pests which attack several economically important crops, including cotton, soybeans, pecans, plums and okra. Although a variety of chemical pesticides have been used in the past to control stink bugs, there are serious disadvantages in these pesticides. Some pesticides pollute the environment while others are toxic to humans. Such environmental and consumer safety concerns have led to the deregistration of many pesticides. Also, there is generally a reluctance to use any pesticides on agricultural products which are consumed as food. Therefore, eliminating, or at least reducing the amount of toxic pesticides used in the management of insect pests is desirable. Consequently, scientists have pursued the development of alternative pest control agents that are safer for the environment and for consumers. Among such alternative control agents are insect sex pheromones.

Many insects communicate by releasing volatile pheromones. Sex pheromones, for example, are typically released by one sex at appropriate times to attract the other sex of the same species. This phenomenon has been exploited to trap the insects of one sex and kill them, thereby preventing mating and reducing the insect population in following generations. Pheromones have been used in this way on a commercial basis for several years, and provide effective control of numerous insect pest species. For stink bugs, the ability to control the population was improved by the identification of the pheromone, methyl (2E,4Z)-decadienoate (Aldrich et al. Environ. Entomol. 20:477-483, 1991).

Aggregation pheromone compounds have been identified from many species of agriculturally important stink bugs. The aggregation pheromone methyl (2E,4E,6Z)-decatrienoate has been found to be cross-attractive to the brown marmorated stink bug. Adults have been found to be reliably attracted late in the season but, in early season trials, this compound has been found to be not attractive by itself.

The brown marmorated stink bug, Halyomorpha halys, is an invasive pest species from Asia and is now well established throughout the U.S. mid-Atlantic region. The brown marmorated stink bug is considered a polyphagous pest of many specialty crops in Asia and the United States including tree fruit, vegetables, shade trees, and row crops with significant economic damage reported in the United States.

The brown marmorated stink bug, in particular, has caused widespread damage to fruits, vegetables, and field crops, including peaches, apples, green beans, soybeans, corn, tomatoes, cherries, raspberries, and pears. It is a sucking insect that uses its proboscis to pierce the host plant in order to feed. This feeding may cause necrotic areas on the outer surface of fruits, leaf stippling, cat-facing on tree fruits, seed loss, and transmission of plant pathogens.

Because of the significant threat posed by the brown marmorated stink bug, growers have turned to aggressive calendar-based insecticide programs to combat brown marmorated stink bug populations. There is a need for a season-long attractant for brown marmorated stink bugs to help growers make informed pest management decisions. Such an attractant could be used to develop effective attract-and-kill or other management technologies to limit insecticide inputs into agroecosystems.

The present disclosure provides many advantages, which shall become apparent as described below.

### SUMMARY OF THE DISCLOSURE

This disclosure relates in part to synergists for stink bug pheromones, and attractant compositions for attracting stink bugs. The compositions comprise pheromones and synergists. The attractant composition attracts insects including, but not limited to, brown marmorated stink bugs, Halyomorpha halys.

This disclosure also relates in part to attractant compositions that contain at least one pheromone and at least one synergist for attracting stink bugs. In preferred embodiments, the synergist/attractant can be an alkyl or alkenyl ester of decadienoic acid or an alkyl or alkenyl ester of decatrienoic acid, and any stereoisomers thereof, and any combinations thereof. The synergist/attractant is preferably at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof such as the (2E,4E,6E)-isomers, and any combinations thereof. The pheromone may be, for example, murgantiol. In some embodiments, the attractant composition further contains one or more additives such as, for example, pesticides, insect sterilants and/or insect growth regulators. The attractant compositions may incorporate inert additives and carriers. The attractant compositions can be in the form of a liquid, pellets, microspheres, nanoparticles, tubules, or combinations thereof.

This disclosure further relates in part to traps for capturing stink bugs, which include one or more septa, laminates, bioflakes or containers for holding the attractant composition.

This disclosure provides a method for attracting and trapping stink bugs, thereby protecting crop plants from stink bugs. The method comprises the steps of attracting stink bugs with an attractant composition of this disclosure; trapping the stink bugs; and killing or sterilizing the trapped stink bugs. Crop plants protected in this manner include, but are not limited to, cotton, soybean, plum, pecan, peach and okra.

In some embodiments, the method may include an additional step of assessing the population of trapped stink bugs. Such assessments may help, periodically, to monitor the stink bug population in a crop field.

Also, in accordance with this disclosure, there are provided compositions useful, for example, to attract the brown marmorated stink bug, Halyomorpha halys. The compositions may contain various combinations of cis and/or trans stereoisomers of 10,11-epoxy-1-bisabolen-3-ol produced from (R)-citronella, and/or trans and/or cis stereoisomers of 10,11-epoxy-1-bisabolen-3-ol produced from (S)-citronella as described herein. These compositions contain two major components of the aggregation pheromone of Halyomorpha halys: (3S,6S,7R,10S)-10,11-epoxy-1-bisabolen-3-ol and (3R,6S,7R,10S)-10,11-epoxy-1-bisabolen-3-ol. These compositions also contain at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof such as the (2E,4E,6E)-isomers, and any combinations thereof.

Further, there are provided methods for attracting Halyomorpha halys to an object or area, involving treating the object or area with a Halyomorpha halys attracting composition containing a Halyomorpha halys attracting effective amount of the compositions described herein.

Further objects, features and advantages of the present disclosure will be understood by reference to the following drawings and detailed description.

### BRIEF DESCRIPTION OF THE DRAWINGS

FIG. 1 contains two images. The image on the left is a scanning electron micrograph (SEM) depicting the sensilla field on the terminal segment of the brown marmorated stink bug antenna. The image on the right is taken through the electrophysiological setup microscope (AO spencer compound microscope) at approximately 500× (10× eyepiece; 50× Long Working Distance objective) as described in the Examples.

FIG. 2 represents an electrophysiological trace from an individual sensillum of the brown marmorated stink bug in response to an olfactory stimulus as described in the Examples.

FIG. 3 represents screen shots of the analysis of the trace in FIG. 2 from the software that used to analyze the electrophysiological data as described in the Examples.

FIG. 4 graphically depicts attraction (total number of brown marmorated stink bug collected) of both adult and nymph brown marmorated stink bug with a control and a formulation containing murgantiol (10 mg) and ethyl (2E,4E,6Z)-decatrienoate (250 mg) as described in the Examples.

FIG. 5 graphically depicts attraction (total number of brown marmorated stink bug collected over time) of both adult and nymph brown marmorated stink bug with a control, murgantiol (10 mg), a formulation containing murgantiol (10 mg) and ethyl (2E,4E,6Z)-decatrienoate (250 mg), ethyl (2E,4E,6Z)-decatrienoate (250 mg), and a USDA standard as described in the Examples.

FIG. 6 graphically depicts attraction (mean numbers of brown marmorated stink bug collected over time) of both adult and nymph brown marmorated stink bug with a USDA standard, murgantiol (10 mg), a formulation containing murgantiol (10 mg) and ethyl (2E,4E,6Z)-decatrienoate (250 mg), a formulation containing murgantiol (10 mg), ethyl (2E,4E,6Z)-decatrienoate and pear ester (250 mg), ethyl (2E,4E,6Z)-decatrienoate (250 mg), and pear ester (500 mg) as described in the Examples. Pear ester is ethyl (2E,4Z)-2,4-decadienoate.

FIG. 7 graphically depicts attraction (mean numbers of brown marmorated stink bug collected over time based on dosage) of both adult and nymph brown marmorated stink bug with a USDA standard, a formulation containing murgantiol (10 mg) and ethyl (2E,4E,6Z)-decatrienoate (250 mg), a formulation containing murgantiol (10 mg) and ethyl (2E,4E,6Z)-decatrienoate (500 mg), and a formulation containing murgantiol (10 mg) and ethyl (2E,4E,6Z)-decatrienoate (750 mg) as described in the Examples.

### DESCRIPTION OF THE PREFERRED EMBODIMENTS

The compositions and methods of this disclosure are useful for attracting an insect from the superfamily Pentatomoidea, such as stink bugs and shield bugs, to an outdoor predetermined location. The method comprises administering to the outdoor predetermined location a composition comprising at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof such as the (2E,4E,6E)-isomers, and any combinations thereof; that attract an insect from the superfamily Pentatomoidea and a synergistic amount of murgantiol. The composition is active in attracting the insect to the outdoor predetermined location. In one embodiment, the insect can be an adult or nymph stink bug, such as the brown marmorated stink bug.

In an embodiment, the attractant compositions of this disclosure contain at least two compounds. The first compound is a pheromone and the second compound is a synergist, as defined herein. The term “pheromone,” as used herein, means a volatile chemical or a set of volatile chemicals that attract stink bugs. The attractant compositions may also contain a feeding attractant compound, as defined herein.

In some embodiments, the pheromone is a sex pheromone which attracts one sex of stink bugs. In preferred embodiments, the pheromone is murgantiol. In other embodiments, the pheromone may be an alkyl or alkenyl ester. In particular embodiments, the alkyl or alkenyl ester is preferably at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof such as the (2E,4E,6E)-isomers, and any combinations thereof. In a preferred embodiment, the pheromone is murgantiol and/or ethyl (2E,4Z)-decadienoate, ethyl (2E,4E,6Z)-decadienoate, ethyl (2Z,4E)-decadienoate, ethyl (2E,4E)-decadienoate, ethyl (2E,4E,6Z)-decatrienoate, and any stereoisomers thereof, and any combinations thereof. The pheromone may be naturally occurring or chemically synthesized by methods known to one skilled in the art.

The term “feeding attractant” as used herein, refers to a volatile chemical or a set of volatile chemicals that attract stink bugs. In some embodiments, the feeding attractant is an alkyl or alkenyl ester. In particular embodiments, the feeding attractant is preferably at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof such as the (2E,4E,6E)-isomers, and any combinations thereof. In a preferred embodiment, the feeding attractant is ethyl (2E,4Z)-decadienoate, ethyl (2E,4E,6Z)-decadienoate, ethyl (2Z,4E)-decadienoate, ethyl (2E,4E)-decadienoate, ethyl (2E,4E,6Z)-decatrienoate, and any stereoisomers thereof, and any combinations thereof. In another embodiment, the attractant may be geraniol (E-(3,7)-dimethyl-2,6-octadien-1-ol, C₁₀H₁₈O) or its Z isomer. The feeding attractant may be naturally occurring or chemically synthesized by methods known to one skilled in the art.

The term, “synergist,” as used herein, refers to a substance that can be used with a stink bug pheromone for reducing the amount of the pheromone dose or enhancing the effectiveness of the pheromone for attracting stink bugs. The synergist may or may not be an independent attractant for stink bugs in the absence of a pheromone.

In preferred embodiments, the synergist is a volatile chemical that attracts stink bugs. In some embodiments, the synergist is an alkyl or alkenyl ester. In particular embodiments, the synergist is preferably at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof such as the (2E,4E,6E)-isomers, and any combinations thereof. In a preferred embodiment, the synergist is ethyl (2E,4Z)-decadienoate, ethyl (2E,4E,6Z)-decadienoate, ethyl (2Z,4E)-decadienoate, ethyl (2E,4E)-decadienoate, ethyl (2E,4E,6Z)-decatrienoate, and any stereoisomers thereof, and any combinations thereof. In another embodiment, the synergist may be murgantiol. The synergist may be naturally occurring or chemically synthesized by methods known to one skilled in the art.

As used herein, pheromones can include synergists and/or attractants, and synergists and/or attractants can include pheromones. The designation of a compound as a pheromone, synergist or attractant herein is not intended to be limiting, but is merely descriptive of one possible form of action of the compound.

In particular, the compositions of this disclosure include one or more compounds that attract an insect from the superfamily Pentatomoidea and a synergistic amount of murgantiol, wherein the murgantiol increases attraction of the insect to the composition outdoors. The compositions may be used to attract a shield bug or stink bug. The compositions can include one or more compounds selected from at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof such as the (2E,4E,6E)-isomers, and any combinations thereof. The compositions can be used to attract a brown marmorated stink bug.

The composition can include murgantiol (CAS#: 1030630-94-4): 4-[3-(3,3-dimethyloxiran-2-yl)-1-methylpropyl]-1-methylcyclohex-2-en-1-ol, any stereoisomer thereof, or any combination of more than one stereoisomer. The compositions can include a racemic mixture of murgantiol stereoisomers. The compositions can include one or more 4R/S isomers of murgantiol. The compositions can include one or more 4S/R isomers of murgantiol. The composition can further include an antioxidant, an oil, or any combination thereof.

Murgantiol may be obtained synthetically as described by Zahn et al., J. Chem. Ecol. 34:238 (2008). Murgantiol is a compound with four chiral centers and 16 possible stereoisomers. The relative and absolute configurations of the insect produced compound were not identified by Zahn et al. and are presently unknown, but the structure was reported as follows, with carbon numbering shown:

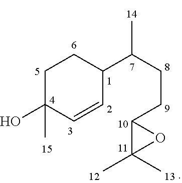 [SMILES: CC(CCC1OC1(C)C)C1C=CC(C)(O)CC1]

As used herein, “murgantiol” refers to any compound or mixture of compounds (isomers) that exhibit the murgantiol skeleton structure noted above. Thus, murgantiol may refer to a single isomer, a mixture of all 16 isomers (racemic murgantiol), or a mixture of any number of these isomers (e.g., a mixture of 2, 3, 4, 5, 6, 7, 8, 9, 10, 11, 12, 13, 14, or 15 isomers, or a mixture of at most or at least 2, 3, 4, 5, 6, 7, 8, 9, 10, 11, 12, 13, 14, or 15 isomers). Murgantiol may comprise a racemic mixture of stereoisomers.

Murgantiol may, for example, entail one or more of the more polar isomers, such as the 4R/S-isomers (4R/S-1S-7S-10S-isomer, 4R/S-1R-7S-10S-isomer, 4R/S-1R-7R-10S-isomer, 4R/S-1R-7R-10R-isomer, 4R/S-1S-7R-10R-isomer, 4R/S-1S-7R-10S-isomer, 4R/S-1S-7S-10R-isomer, and the 4R/S-1R-7S-10R-isomer). Murgantiol may, for example, entail one or more of the less polar isomers, such as the 4S/R-isomers (4S/R-1S-7S-10S-isomer, 4S/R-1R-7S-10S-isomer, 4S/R-1R-7R-10S-isomer, 4S/R-1R-7R-10R-isomer, 4S/R-1S-7R-10R-isomer, 4S/R-1S-7R-10S-isomer, 4S/R-1 S-7S-10R-isomer, and the 4S/R-1R-7S-10R-isomer). Murgantiol may entail four isomers, such as the 4R/S-7R/S-isomers (4R/S-7R/S-1R-10R-isomer, 4R/S-7R/S-1R-10S-isomer, 4R/S-7R/S-1 S-10S-isomer, and the 4R/S-7R/S-1S-10R-isomer); the 4R/S-7S/R-isomers (4R/S-7S/R-1R-10R-isomer, 4R/S-7S/R-1R-10S-isomer, 4R/S-7S/R-1S-10S-isomer, and the 4R/S-7S/R-1S-10R-isomer); the 4S/R-7R/S-isomers (4S/R-7R/S-1R-10R-isomer, 4S/R-7R/S-1R-10S-isomer, 4S/R-7R/S-1S-10S-isomer, and the 4S/R-7R/S-1S-10R-isomer); and the 4S/R-7S/R-isomers (4S/R-7S/R-1R-10R-isomer, 4S/R-7S/R-1R-10S-isomer, 4S/R-7S/R-1S-10S-isomer, and the 4S/R-7S/R-1S-10R-isomer). In some embodiments, murgantiol is further defined as a mixture of diastereomers of 4-[(1S)-3-(3,3-dimethyloxiran-2-yl)-1-methylpropyl]-1-methylcyclohex-2-en-1-ol [(S)-murgantiol; CAS#: 1030630-97-7]. In some embodiments, murgantiol is further defined as a mixture of diastereomers of 4-[(1R)-3-(3,3-dimethyloxiran-2-yl)-1-methylpropyl]-methylcyclohex-2-en-1-ol [(R)-murgantiol].

In some embodiments, a composition comprises an isolated mixture defined as a more polar mixture of murgantiol stereoisomers obtained and separated from a racemic mixture, such as a more polar mixture of murgantiol stereoisomers (4R/S-isomers). In some embodiments, a composition comprises an isolated mixture defined as a less polar mixture of murgantiol stereoisomers obtained and separated from a racemic mixture, such as a less polar mixture of murgantiol stereoisomers (4S/R-isomers). The “more polar mixture” and the “less polar mixture” can be obtained and separated from a racemic mixture of murgantiol by flash chromatography on silica gel, eluting with 10% ethyl acetate in hexane, with the first fraction being the less polar murgantiol mixture and the later eluting fraction being the more polar murgantiol mixture. Each fraction includes 8 isomers that are inseparable by the flash chromatography. As noted herein, a composition may comprise either the 8 less polar isomers or the 8 more polar isomers. In some embodiments, a composition comprises a racemic mixture of murgantiol stereoisomers (all 16 stereoisomers).

As used herein, an “effective amount” of murgantiol is an amount effective to achieve a desired result, such as to attract an insect to an outdoor predetermined location, such as a trap that is outdoors. The effective amount of murgantiol, when used alone or as a synergistic combination with other attractant compositions, may be determined experimentally. For example, both an effective amount, and a synergistic amount of murgantiol can be at least or at most 0.01, 0.1, 10, 20, 30, 40, 50 60, 70, 80, 90, 100, 200, 300, 400, or 500 mg of murgantiol, and any range derivable therein. While representative amounts have been provided to illustrate exemplary embodiments, it is believed that any amount of murgantiol will be effective to attract insects, and to increase the attraction of other known attractants. Murgantiol may be used in a composition further comprising one or more different attractants, semiochemicals, oils, antioxidants, or other additives, or any combination thereof.

As used herein, a “synergistic amount” of murgantiol refers to an amount that significantly increases the attraction effects of other attractant compounds.

The composition of this disclosure includes one or more compounds that attract an insect from the superfamily Pentatomoidea, and a synergistic amount of murgantiol. The murgantiol significantly increases attraction of the insect to the composition outdoors. The composition of this disclosure may be used to attract an insect from one species of shield bug or stink bug. The composition may include murgantiol in any amount. The composition may include at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof. The composition may be used to attract a brown marmorated stink bug.

The compositions of this disclosure may include murgantiol: 4-[3-(3,3-dimethyloxiran-2-yl)-1-methylpropyl]-1-methylcyclohex-2-en-1-ol, any stereoisomer thereof, or any combination of more than one stereoisomer. The composition may include a racemic mixture of murgantiol stereoisomers. The composition may include one or more 4R/S isomers of murgantiol. The composition may include one or more 4S/R isomers of murgantiol. The composition may further include an antioxidant, an oil, or any combination thereof.

The compositions of this disclosure may include at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof. Illustrative alkyl groups of the esters include, for example, alkyl groups having from 1 to about 24 carbon atoms, preferably 2 to about 24 carbon atoms, more preferably 2 to about 12 carbon atoms, even more preferably 2 to about 10 carbon atoms, in particular, methyl, ethyl, propyl, and the like.

In an embodiment, the compositions of this disclosure may contain various combinations of cis and/or trans stereoisomers of 10,11-epoxy-1-bisabolen-3-ol produced from (R)-citronella, and/or trans and/or cis stereoisomers of 10,11-epoxy-1-bisabolen-3-ol produced from (S)-citronella as described herein. These compositions contain two major components of the aggregation pheromone of Halyomorpha halys: (3S,6S,7R,10S)-10,11-epoxy-1-bisabolen-3-ol and (3R,6S,7R,10S)-10,11-epoxy-1-bisabolen-3-ol. These compositions also contain at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof.

The composition (1) can comprise at least one member selected from (3R,6R,7R,10S)-10,11-epoxy-1-bisabolen-3-ol (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof, and optionally a carrier material or carrier. The above composition (1) comprising at least two members selected from (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (1) comprising at least three members selected from (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (1) comprising (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, and (3S,6S,7R,10R)-10,11-epoxy-1-bisabolen-3-ol.

The above composition (1) can further comprise at least one member selected from (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (1) can further comprise at least two members selected from (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (1) can further comprise at least three members selected from (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (1) can further comprise (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, and (3S,6R,7R,10R)-10,11-epoxy-1-bisabolen-3-ol.

The above composition (1) can further comprise at least one of (3R,6R,7S,10S)-10,11-epoxy-1-bisabolen-3-ol, 3R,6R,7S,10R)-10,11-epoxy-1-bisabolen-3-ol, 3S,6S,7S,10S)-10,11-epoxy-1-bisabolen-3-ol, 3S,6S,7S,10R)-10,11-epoxy-1-bisabolen-3-ol, (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, and mixtures thereof.

The above composition (1) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof.

The above composition (1) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof; and murgantiol.

The above composition (1) can further comprise at least one of 10,11-epoxy-1,3(15)-bisaboladiene, 10,11-epoxy-1,3-bisaboladiene, 10,11-epoxy-1,3,5-bisabotriene, (3S,6S,7S,10R)-10,11-epoxy-1-bisabolen-3-ol, and mixtures thereof.

A method for attracting Halyomorpha halys to an object or area comprising treating said object or area with a Halyomorpha halys attracting composition comprising a Halyomorpha halys attracting effective amount of the above composition (1).

A kit for attracting Halyomorpha halys comprising: (a) first attractant comprised of the above composition (1) on a first carrier, and (b) a second attractant comprised of at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof, on a second carrier or on said first carrier. The above kit further comprising an insect trap for housing said first and second carriers. The above kit further comprising written instructions directed to deploying the attractants at separate seasonal times. The above kit further comprising a third carrier and one or more insecticides on the third carrier.

The composition (2) can comprise at least one of (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof, and optionally a carrier material or carrier. The above composition (2) can comprise at least two of (3R,65,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (2) can comprise at least three of (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (2) can comprise (3R,65,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, and (3S,6R,7R,10R)-10,11-epoxy-1-bisabolen-3-ol.

The above composition (2) can further comprise at least one of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (2) can further comprise at least two of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (2) can further comprise at least three of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (2) can further comprise (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, and (3S,6S,7R,10R)-10,11-epoxy-1-bisabolen-3-ol.

The above composition (2) can further comprise at least one of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, and mixtures thereof. The above composition (2) can further comprise at least two of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, and mixtures thereof. The above composition (2) can further comprise at least three of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, and mixtures thereof. The above composition (2) can further comprise (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, and (3S,6S,7S,10R)-10,11-epoxy-1-bisabolen-3-ol.

The above composition (2) can further comprise at least one of (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, and mixtures thereof. The above composition (2) can further comprise at least two of (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, and mixtures thereof. The above composition (2) can further comprise at least three of (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, and mixtures thereof. The above composition (2) can further comprise (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, and (3S,6R,7S,10S)-10,11-epoxy-1-bisabolen-3-ol.

The above composition (2) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof.

The above composition (2) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof; and murgantiol.

The above composition (2) can further comprise at least one of 10,11-epoxy-1,3(15)-bisaboladiene, 10,11-epoxy-1,3-bisaboladiene, 10,11-epoxy-1,3,5-bisabotriene, (3S,6S,7S,10R)-10,11-epoxy-1-bisabolen-3-ol, and mixtures thereof.

A method for attracting Halyomorpha halys to an object or area comprising treating said object or area with a Halyomorpha halys attracting composition comprising a Halyomorpha halys attracting effective amount of the above composition (2).

A kit for attracting Halyomorpha halys comprising: (a) first attractant comprised of the above composition (2) on a first carrier, and (b) a second attractant comprised of at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof, on a second carrier or on said first carrier. The above kit further comprising an insect trap for housing said first and second carriers. The above kit further comprising written instructions directed to deploying the attractants at separate seasonal times. The above kit further comprising a third carrier and one or more insecticides on the third carrier.

The composition (3) can comprise at least one of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof, and optionally a carrier material or carrier. The above composition (3) can comprise at least one of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (3) can comprise at least two of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (3) can comprise at least three of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (3) can comprise (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, and (3S,6S,7R,10R)-10,11-epoxy-1-bisabolen-3-ol.

The above composition (3) can comprise at least one of (3R,6S,7R,10S)-10,11-epoxy-1-bisabolen-3-ol, (3R,6S,7R,10R)-10,11-epoxy-1-bisabolen-3-ol, (3S,6RR,10S)-10,11-epoxy-1-bisabolen-3-ol, (3S,6R,7R,10R)-10,11-epoxy-1-bisabolen-3-ol, and mixtures thereof. The above composition (3) can comprise at least two of (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (3) can comprise at least three of (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (3) can comprise (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, and (3S,6R,7R,10R)-10,11-epoxy-1-bisabolen-3-ol.

The above composition (3) can further comprise at least one of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, (3R,65,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-S-ol, and mixtures thereof.

The above composition (3) can further comprise at least one of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, and mixtures thereof. The above composition (3) can further comprise at least two of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, and mixtures thereof. The above composition (3) can further comprise at least three of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, and mixtures thereof. The above composition (3) can further comprise (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, and (3S,6S,7S,10R)-10,11-epoxy-1-bisabolen-3-ol.

The above composition (3) can further comprise at least one of (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11 epoxy-1-bisabolen-3-ol, and mixtures thereof. The above composition (3) can further comprise at least two of (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, and mixtures thereof. The above composition (3) can further comprise at least three of (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, and mixtures thereof. The above composition (3) can further comprise (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, and (3S,6R,7S,10S)-10,11-epoxy-1-bisabolen-3-ol.

The above composition (3) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof.

The above composition (3) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof; and murgantiol.

The above composition (3) can further comprise at least one of 10,11-epoxy-1,3(15)-bisaboladiene, 10,11-epoxy-1,3-bisaboladiene, 10,11-epoxy-1,3,5-bisabotriene, (3S,6S,7S,10R)-10,11-epoxy-1-bisabolen-3-ol, and mixtures thereof.

A method for attracting Halyomorpha halys to an object or area comprising treating said object or area with a Halyomorpha halys attracting composition comprising a Halyomorpha halys attracting effective amount of the above composition (3).

A kit for attracting Halyomorpha halys comprising: (a) first attractant comprised of the above composition (3) on a first carrier, and (b) a second attractant comprised of at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof, on a second carrier or on said first carrier. The above kit further comprising an insect trap for housing said first and second carriers. The above kit further comprising written instructions directed to deploying the attractants at separate seasonal times. The above kit further comprising a third carrier and one or more insecticides on the third carrier.

The composition (4) can comprise at least one of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, and mixtures thereof, and optionally a carrier material or carrier. The above composition (4) can comprise at least two of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, and mixtures thereof. The above composition (4) can comprise at least three of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, and mixtures thereof. The above composition (4) can comprise (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, and (3S,6S,7S,10R)-10,11-epoxy-1-bisabolen-3-ol.

The above composition (4) can further comprise at least one of (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, and mixtures thereof. The above composition (4) can further comprise at least two of (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, and mixtures thereof. The above composition (4) can further comprise at least three of (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, and mixtures thereof. The above composition (4) can further comprise (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, and (3S,6R,7S,10S)-10,11-epoxy-1-bisabolen-3-ol.

The above composition (4) can further comprise at least one of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (4) can further comprise at least one of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (4) can further comprise at least two of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (4) can further comprise at least three of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (4) can further comprise (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, and (3S,6S,7R,10R)-10,11-epoxy-1-bisabolen-3-ol.

The above composition (4) can further comprise at least one of (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (4) can further comprise at least two of (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (4) can further comprise at least three of (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (4) can further comprise (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, and (3S,6R,7R,10R)-10,11-epoxy-1-bisabolen-3-ol.

The above composition (4) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof.

The above composition (4) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof; and murgantiol.

The above composition (4) can further comprise at least one of 10,11-epoxy-1,3(15)-bisaboladiene, 10,11-epoxy-1,3-bisaboladiene, 10,11-epoxy-1,3,5-bisabotriene, (3S,6S,7S,10R)-10,11-epoxy-1-bisabolen-3-ol, and mixtures thereof.

A method for attracting Halyomorpha halys to an object or area comprising treating said object or area with a Halyomorpha halys attracting composition comprising a Halyomorpha halys attracting effective amount of the above composition (4).

A kit for attracting Halyomorpha halys comprising: (a) first attractant comprised of the above composition (4) on a first carrier, and (b) a second attractant comprised of at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof, on a second carrier or on said first carrier. The above kit further comprising an insect trap for housing said first and second carriers. The above kit further comprising written instructions directed to deploying the attractants at separate seasonal times. The above kit further comprising a third carrier and one or more insecticides on the third carrier.

The composition (5) can comprise at least one of (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, and mixtures thereof, and optionally a carrier material or carrier. The above composition (5) can comprise at least two of (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, and mixtures thereof. The above composition (5) can comprise at least three of (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, and mixtures thereof. The above composition (5) can comprise (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, and (3S,6R,7S,10S)-10,11-epoxy-1-bisabolen-3-ol.

L The above composition (5) can further comprise at least one of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, and mixtures thereof. The above composition (5) can further comprise at least two of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, and mixtures thereof. The above composition (5) can further comprise at least three of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, and mixtures thereof. The above composition (5) can further comprise (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, and (3S,6S,7S,10R)-10,11-epoxy-1-bisabolen-3-ol.

The above composition (5) can further comprise at least one of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof.

The above composition (5) can further comprise at least one of (3R,6R,7R,10S)-10,11-epoxy-1-bisabolen-3-ol, (3R,6R,1R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (5) can further comprise at least two of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (5) can further comprise at least three of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (5) can further comprise (3R,6R,7R,10S)-10,11-epoxy-1-bisabolen-3-ol, (3R,6R,1R,10R)-10,11-epoxy-1-bisabolen-3-ol, (3S,6S,7R,10S)-10,11-epoxy-1-bisabolen-3-ol, and (3S,6S,7R,10R)-10,11-epoxy-1-bisabolen-3-ol.

The above composition (5) can further comprise at least one of (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (5) can further comprise at least two of (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (5) can further comprise at least three of (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (5) can further comprise (or (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, and (3S,6R,7R,10R)-10,11-epoxy-1-bisabolen-3-ol.

The above composition (5) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof.

The above composition (5) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof; and murgantiol.

The above composition (5) can further comprise at least one of 10,11-epoxy-1,3(15)-bisaboladiene, 10,11-epoxy-1,3-bisaboladiene, 10,11-epoxy-1,3,5-bisabotriene, (3S,6S,7S,10R)-10,11-epoxy-1-bisabolen-3-ol, and mixtures thereof.

A method for attracting Halyomorpha halys to an object or area comprising treating said object or area with a Halyomorpha halys attracting composition comprising a Halyomorpha halys attracting effective amount of the above composition (5).

A kit for attracting Halyomorpha halys comprising: (a) first attractant comprised of the above composition (5) on a first carrier, and (b) a second attractant comprised of at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof, on a second carrier or on said first carrier. The above kit further comprising an insect trap for housing said first and second carriers. The above kit further comprising written instructions directed to deploying the attractants at separate seasonal times. The above kit further comprising a third carrier and one or more insecticides on the third carrier.

The composition (6) can comprise at least one of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, and mixtures thereof.

The above composition (6) can comprise at least one of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, and mixtures thereof. The above composition (6) can comprise at least two of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, and mixtures thereof. The above composition (6) can comprise at least three of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, and mixtures thereof. The above composition (6) can comprise (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, and (3S,6S,7S,10R)-10,11-epoxy-1-bisabolen-3-ol.

The above composition (6) can comprise at least one of (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, and mixtures thereof. The above composition (6) can comprise at least two of (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, and mixtures thereof. The above composition (6) can comprise at least three of (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, and mixtures thereof. The above composition (6) can comprise (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, and (3S,6R,7S,10S)-10,11-epoxy-1-bisabolen-3-ol.

The above composition (6) can further comprise at least one of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof.

The above composition (6) can further comprise at least one of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (6) can further comprise at least two of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (6) can further comprise at least three of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and mixtures thereof. The above composition (6) can further comprise (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, and (3S,6S,7R,10R)-10,11-epoxy-1-bisabolen-3-ol.

The above composition (6) can further comprise at least one of (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (6) can further comprise at least two of (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (6) can further comprise at least three of (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, and mixtures thereof. The above composition (6) can further comprise (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, and (3S,6R,7R,10R)-10,11-epoxy-1-bisabolen-3-ol.

The above composition (6) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof.

The above composition (6) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof; and murgantiol.

The above composition (6) can further comprise at least one of 10,11-epoxy-1,3(15)-bisaboladiene, 10,11-epoxy-1,3-bisaboladiene, 10,11-epoxy-1,3,5-bisabotriene, (3S,6S,7S,10R)-10,11-epoxy-1-bisabolen-3-ol, and mixtures thereof.

A method for attracting Halyomorpha halys to an object or area comprising treating said object or area with a Halyomorpha halys attracting composition comprising a Halyomorpha halys attracting effective amount of the above composition (6).

A kit for attracting Halyomorpha halys comprising: (a) first attractant comprised of the above composition (6) on a first carrier, and (b) a second attractant comprised of at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof, on a second carrier or on said first carrier. The above kit further comprising an insect trap for housing said first and second carriers. The above kit further comprising written instructions directed to deploying the attractants at separate seasonal times. The above kit further comprising a third carrier and one or more insecticides on the third carrier.

A method of making a mixture of (3R,6R,7S,10S)-10,11-epoxy-1-bisabolen-3-ol, 3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, and (3S,6R,7S,10S)-10,11-epoxy-1-bisabolen-3-ol, comprising reacting (S)-citronellal with formaldehyde in the presence of piperidine to form (S)-2-methylenecitronellal, reacting (S)-2-methylenecitronellal with methyl acetoacetonate to form (7S)-7,11-dimethyl-1,10-bisaboladien-3-one, reacting (7S)-7,11-dimethyl-1,10-bisaboladien-3-one with methyl lithium to form trans-(7S)-3,7,11-trimethyl-1,10-bisaboladien-3-ols and cis-(7S)-3,7,11-trimethyl-1,10-bisaboladien-3-ols; separating trans-(7S)-3,7,11-trimethyl-1,10-bisaboladien-3-ols and cis-(7S)-3,7,11-trimethyl-1,10-bisaboladien-3-ols; and reacting trans-(7S)-3,7,11-trimethyl-1,10-bisaboladien-3-ols with m-chloroperbenzoic acid to form trans-10,11-epoxy-1-bisabolen-3-ols; and reacting cis-(7S)-3,7,11-trimethyl-1,10-bisaboladien-3-ols with m-chloroperbenzoic acid to form cis-10,11-epoxy-1-bisabolen-3-ols.

A method of making (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, and (3S,6R,7R,10R)-10,11-epoxy-1-bisabolen-3-ol, comprising reacting (R)-citronellal with formaldehyde in the presence of piperidine to form (R)-2-methylenecitronellal, reacting (R)-2-methylenecitronellal with methyl acetoacetonate to form (7R)-7,11-dimethyl-1,10-bisaboladien-3-one, reacting (7R)-7,11-dimethyl-1,10-bisaboladien-3-one with methyl lithium to form trans-(7R)-3,7,11-trimethyl-1,10-bisaboladien-3-ols and cis-(7R)-3,7,11-trimethyl-1,10-bisaboladien-3-ols; separating trans-(7R)-3,7,11-trimethyl-1,10-bisaboladien-3-ols and cis-(7R)-3,7,11-trimethyl-1,10-bisaboladien-3-ols; and reacting trans-(7R)-3,7,11-trimethyl-1,10-bisaboladien-3-ols with m-chloroperbenzoic acid to produce trans-epoxybisabolenols; and reacting cis-(7R)-3,7,11-trimethyl-1,10-bisaboladien-3-ols with m-chloroperbenzoic acid to produce cis-epoxybisabolenols.

The composition (7) can comprise (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, and optionally a carrier material or carrier. The above composition (7) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof.

The above composition (7) can further comprise (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol. The above composition (7) can contains about 21% cis-epoxybisabolenols and about 41% trans-epoxybisabolenols. The above composition (7) can further contain 1,2,10,11-diepoxybisabolan-3-ols. The above composition (7) can contain about 37% 1,2,10,11-diepoxybisabolan-3-ols. The above composition (7) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof.

The above composition (7) can contain a 3:1 ratio of cis-epoxybisabolenols:trans-epoxybisabolenols produced from (R)-citronellal.

The above composition (7) can further comprise (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol.

The above composition (7) can further comprise (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol.

The above composition (7) can further comprise (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, (3R,6S,7S,10R)-10,11-epoxy-1-bisabolen-3-ol, (3S,6R,7S,10R)-10,11-epoxy-1-bisabolen-3-ol, (3R,6S,7S,10S)-10,11 l-epoxy-1-bisabolen-3-ol, (3S,6R,7S,10S)-10,11-epoxy-1-bisabolen-3-ol. The above composition (7) can contain a 3:1 ratio of cis-epoxybisabolenols:trans-epoxybisabolenols produced from (S)-citronellal.

The above composition (7) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof.

The above composition (7) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof; and murgantiol.

A method for attracting Halyomorpha halys to an object or area comprising treating said object or area with a Halyomorpha halys attracting composition comprising a Halyomorpha halys attracting effective amount of the above composition (7).

A kit for attracting Halyomorpha halys comprising: (a) first attractant comprised of the above composition (7) on a first carrier, and (b) a second attractant comprised of at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof, on a second carrier or on said first carrier. The above kit further comprising an insect trap for housing said first and second carriers. The above kit further comprising written instructions directed to deploying the attractants at separate seasonal times. The above kit further comprising a third carrier and one or more insecticides on the third carrier.

The composition (8) can comprise (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, and optionally a carrier material or carrier.

The above composition (8) can further comprise (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol.

The above composition (8) can contain a 3:1 ratio of cis-epoxybisabolenols:trans-epoxybisabolenols produced from (S)-citronellal.

The above composition (8) can further comprise (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol.

The above composition (8) can further comprise (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol. The above composition (8) can contain a 3:1 ratio of cis-epoxybisabolenols:trans-epoxybisabolenols produced from (R)-citronellal.

The above composition (8) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof.

The above composition (8) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof; and murgantiol.

A method for attracting Halyomorpha halys to an object or area comprising treating said object or area with a Halyomorpha halys attracting composition comprising a Halyomorpha halys attracting effective amount of the above composition (8).

A kit for attracting Halyomorpha halys comprising: (a) first attractant comprised of the above composition (8) on a first carrier, and (b) a second attractant comprised of at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof, on a second carrier or on said first carrier. The above kit further comprising an insect trap for housing said first and second carriers. The above kit further comprising written instructions directed to deploying the attractants at separate seasonal times. The above kit further comprising a third carrier and one or more insecticides on the third carrier.

The composition (9) can comprise (3R,6R,7R,10S)-10,11-epoxy-1-bisabolen-3-ol, (3R,6R,7R,1OR)-10,11-epoxy-1-bisabolen-3-ol, (3S,6S,7R,1OS)-10,11-epoxy-1-bisabolen-3-ol, (3S,6S,7R,1OR)-10,11-epoxy-1-bisabolen-3-ol, (3R,6S,7R,1OS)-10,11-epoxy-1-bisabolen-3-ol, (3R,6S,7R,1OR)-10,11-epoxy-1-bisabolen-3-ol, (3S,6R,7R,1OS)-10,11-epoxy-1-bisabolen-3-ol, (3S,6R,7R,10R)-10,11-epoxy-1-bisabolen-3-ol, (3R,6R,7S,1OS)-10,11-epoxy-1-bisabolen-3-ol (19), 3R,6R,7S,10R)-10,11-epoxy-1-bisabolen-3-ol, 3S,6S,7S,1OS)-10,11-epoxy-1-bisabolen-3-ol, 3S,6S,7S,1OR)-10,11-epoxy-1-bisabolen-3-ol, (3R,6S,7S,10R)-10,11-epoxy-1-bisabolen-3-ol, (35,6R,75,10R)-10,11-epoxy-1-bisabolen-3-ol, (3R,65,7S,10S)-10,11-epoxy-1-bisabolen-3-ol, (35,6R,7S,10S)-10,11-epoxy-1-bisabolen-3-ol, and optionally a carrier material or carrier.

The above composition (9) can contain a 3:1 ratio of cis-epoxybisabolenols:trans-epoxybisabolenols produced from (R)-citronellal and the composition contains a 3:1 ratio of cis-epoxybisabolenol:trans-epoxybisabolenols produced from (S)-citronellal.

The above composition (9) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof.

The above composition (9) can further comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof; and murgantiol.

A method for attracting Halyomorpha halys to an object or area comprising treating said object or area with a Halyomorpha halys attracting composition comprising a Halyomorpha halys attracting effective amount of the above composition (9).

A kit for attracting Halyomorpha halys comprising: (a) first attractant comprised of the above composition (9) on a first carrier, and (b) a second attractant comprised of at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof, on a second carrier or on said first carrier. The above kit further comprising an insect trap for housing said first and second carriers. The above kit further comprising written instructions directed to deploying the attractants at separate seasonal times. The above kit further comprising a third carrier and one or more insecticides on the third carrier.

The composition (10) can comprise (3S,6S,7R,10S)-10,11-epoxy-1-bisabolen-3-ol and optionally a carrier material or carrier.

The composition (11) can comprise (3R,6S,7R,10S)-10,11-epoxy-1-bisabolen-3-ol (3) and optionally a carrier material or carrier.

The composition (12) can comprise (3S,6S,7R,10S)-10,11-epoxy-1-bisabolen-3-ol (1), (3R,6S,7R,10S)-10,11-epoxy-1-bisabolen-3-ol (3), and optionally a carrier material or carrier.

A method to synthesize eight stereoisomers of 1,10-bisaboladien-3-ol, comprising reacting (7R)-1,10-bisaboladien-3-one and/or (7S)-1,10-bisaboladien-3-one with trimethylaluminum in the presence of chloro(1,5-cyclooctadiene)rhodium(I) dimer and (R) and/or (S)-2,2′-bis(diphenylphosphino)-1,1′-binaphthalene.

A method of preparing a composition containing (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol. The method comprises reacting (7R)-1,10-bisaboladien-3-one with methyl lithium (at about −15° C. to about −20° C. (e.g., −15° C. to −20° C.)) (in dry ether) to form cis- and trans-1,10-bisaboladien-3-ols mixture, and further epoxidizing said cis- and trans-1,10-bisaboladien-3-ols mixture with meto-chloroperbenzoic acid (at about 0° C. to about 5° C. (e.g., 0° C. to 5° C.)). The method does not utilize chromatographic separation.

The above method wherein said composition contains about 21% cis-epoxybisabolenols and about 41% trans-epoxybisabolenols.

The above method wherein the composition further comprises 1,2,10,11-diepoxybisabolan-3-ols. The above method wherein the composition further comprises 37% 1,2,10,11-diepoxybisabolan-3-ols.

The above composition which contains (3R,6S,7R,10S)-10,11-epoxy-1-bisabolen-3-ol.

The above composition which does not contain (3R,6S,7R,10S)-10,11-epoxy-1-bisabolen-3-ol.

The above composition which contains (3R,6S,7R,10R)-10,11-epoxy-1-bisabolen-3-ol.

The above composition which does not contain (3R,6S,7R,10R)-10,11-epoxy-1-bisabolen-3-ol.

The above composition which contains (3S,6R,7R,10S)-10,11-epoxy-1-bisabolen-3-ol.

The above composition which does not contain (3S,6R,7R,10S)-10,11-epoxy-1-bisabolen-3-ol.

The above composition which contains (3S,6R,7R,10R)-10,11-epoxy-1-bisabolen-3-ol.

The above composition which does not contain (3S,6R,7R,10R)-10,11-epoxy-1-bisabolen-3-ol.

The above composition which contains (3R,6R,7S,10S)-10,11-epoxy-1-bisabolen-3-ol.

The above composition which does not contain (3R,6R,7S,10S)-10,11-epoxy-1-bisabolen-3-ol.

The above composition which contains (3R,6R,7S,10R)-10,11-epoxy-1-bisabolen-3-ol.

The above composition which does not contain (3R,6R,7S,10R)-10,11-epoxy-1-bisabolen-3-ol.

The above composition which contains (3S,6S,7S,10S)-10,11-epoxy-1-bisabolen-3-ol.

The above composition which wherein does not contain (3S,6S,7S,10S)-10,11-epoxy-1-bisabolen-3-ol.

The above composition which contains (3S,6S,7S,10R)-10,11-epoxy-1-bisabolen-3-ol.

The above composition which does not contain (3S,6S,7S,10R)-10,11-epoxy-1-bisabolen-3-ol.

The above composition which contains (3R,6S,7S,10R)-10,11-epoxy-1-bisabolen-3-ol.

The above composition which does not contain (3R,6S,7S,10R)-10,11-epoxy-1-bisabolen-3-ol.

The above composition which contains (3S,6R,7S,10R)-10,11-epoxy-1-bisabolen-3-ol.

The above composition which does not contain (3S,6R,7S,10R)-10,11-epoxy-1-bisabolen-3-ol.

The above composition which contains (3R,6S,7S,10S)-10,11-epoxy-1-bisabolen-3-ol.

The above composition which does not contain (3R,6S,7S,10S)-10,11-epoxy-1-bisabolen-3-ol.

The above composition which contains (3S,6R,7S,10S)-10,11-epoxy-1-bisabolen-3-ol.

The above composition which does not contain (3S,6R,7S,10S)-10,11-epoxy-1-bisabolen-3-ol.

A method of preparing a composition containing (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol. The method comprises reacting (7R)-1,10-bisaboladien-3-one with methyl lithium at about −15° C. to about −20° C. in dry ether to form cis- and trans-1,10-bisaboladien-3-ols mixture, and further epoxidizing the cis- and trans-1,10-bisaboladien-3-ols mixture with meta-chloroperbenzoic acid at about 0° C. to about 5° C. The method does not utilize chromatographic separation.

A method for attracting Halyomorpha halys to an object or area, comprising treating said object or area with a Halyomorpha halys attracting composition comprising a Halyomorpha halys attracting effective amount of at least one compound described herein (or one of the compositions described herein). The compound(s) or compositions(s) are used to treat an object or area in amounts effective to attract Halyomorpha halys to the object or area. As used herein “a Halyomorpha halys attracting effective amount” refers to an amount which attracts Halyomorpha halys compared to objects or areas which were not treated according to methods described herein. Any accurate method for measuring attraction may be used for such comparisons, as would be apparent to those skilled in the art. As used herein “in amounts effective” or “an effective amount” refers to the amount of the compounds(s) or composition(s) wherein the effect of the treatment acts to attract Halyomorpha halys to the object or area.

Illustrative pheromone compounds and synergist compounds useful in this disclosure are described, for example, in WO 2013/090703, U.S. Pat. No. 8,663,620, and U.S. Pat. No. 7,824,668, the disclosures of which are incorporated by reference in their entirety.

The method of this disclosure for attracting an insect outdoors, includes administering an effective amount of any embodiment of the composition to an outdoor location, and attracting an insect belonging to the superfamily Pentatomoidea to the outdoor location. The composition is active in attracting the insect. In some embodiments, the insect may be a stink bug. In some embodiments, the insect may be a brown marmorated stink bug. In some embodiments, the insect may be an overwintered adult during spring or early summer outdoors. In some embodiments, the insect may be a juvenile (nymph) or new generation adult stink bug during summer and fall seasons outdoors.

The compositions may “consist essentially” of a synergistic amount of murgantiol and one or more different attractants. Such compositions include the specified compounds and those compounds that do not materially affect the basic and novel characteristics of the composition. For example, antioxidants, oils, and impurities may be comprised in such compositions.

The compositions may “consist” of a synergistic amount of murgantiol and one or more different attractants. Such compositions include only the specified compounds, and exclude all other compounds.

Various additives may be combined with the compositions, including, but not limited to, antioxidants and oils. Suitable antioxidants for use with any of the murgantiol-containing compositions include, but are not limited to, tocopherols, α-tocopherol, ascorbic acid, as well as synthetic antioxidants such as propyl gallate, tertiary butylhydroquinone, butylated hydroxytoluene (BHT), and butylated hydroxyanisole (BHA). BHT or BHA, among other similar antioxidant compounds, are soluble in most of the compositions and can react efficiently with oxygen in the dispensing systems, and therefore offer a way to avoid oxidation, breakdown, and polymerization of the compositions. One class of antioxidants are lipophilic (fat-soluble) organic compounds that are primarily used as antioxidant food additives.

Suitable antioxidants also include polar antioxidants, such as phenolic alcohols, flavonoids, catechins, anthocyanins, and their glycosides. The polar phenolics are advantageous for stabilization of polar compounds.

While representative oxidants have been listed for purposes of illustrating embodiments of the disclosure, it is to be appreciated that other antioxidants not specifically listed above may also be used.

Suitable oils to use with the compositions of this disclosure include, but are not limited to, oils derived from plants such as vegetable oils and nut oils. These are widely available and cost effective. Suitable oils include, but are not limited to, canola oil, cottonseed oil, palm oil, safflower oil, soybean oil, corn oil, olive oil, peanut oil, sunflower oil, sesame oil, nut oils, and coconut oils, among many others. Nut oils include, but are not limited to, almond oil, cashew oil, hazelnut oil, macadamia oil, mongongo nut oil, pecan oil, pine nut oil, pistachio oil, sacha inchi oil, and walnut oil, plus many others. Melon and gourd seed oils are very common and inexpensive. The oils listed above include saturated, monounsaturated, and polyunsaturated fatty acids that are soluble in many compositions, especially the less polar or non-polar ones.

While representative oils have been listed for purposes of illustrating embodiments of the disclosure, it is to be appreciated that other oils not specifically listed above may also be used.

The oils and antioxidants can be combined with murgantiol and other attractants for stabilizing murgantiol and the attractants against oxidation or for controlling the release rate from a dispenser.

The method of this disclosure involves attracting an insect outdoors, and includes administering an effective amount of any embodiment of the first composition to an outdoor location, and attracting an insect belonging to the superfamily Pentatomoidea to the outdoor location. The compositions of this disclosure are active in attracting the insect. In some embodiments, the insect may be a stink bug. In some embodiments, the insect may be a brown marmorated stink bug. In some embodiments, the insect may be an adult outdoors. In some embodiments, the insect may be a nymph outdoors.

Capturing overwintered insects soon after they leave their overwintering indoor sites, and before their mating and oviposition period, can reduce their early season populations and minimize both damage to host plants and late season home invasions. The methods and compositions disclosed herein are effective to attract and/or trap not only these overwintered adult insects in early summer, but also their juveniles (nymphs) and new generation adults during summer and fall seasons. Such insects can include stink bugs, including the brown marmorated stink bug, and shield bugs.

The compounds described herein (useful, for example, in attracting the brown marmorated stink bug) may be applied with a carrier component or carrier (e.g., agronomically or physiologically or pharmaceutically acceptable carrier). The carrier component can be a liquid or a solid material. As is known in the art, the vehicle or carrier to be used refers to a substrate such as a membrane, hollow fiber, microcapsule, cigarette filter, gel, polymers, septa, laminate, bioflakes, or the like. All of these substrates have been used to release insect pheromones in general and are well known in the art. Suitable carriers are well-known in the art and are selected in accordance with the ultimate application of interest. Agronomically acceptable substances include aqueous solutions, glycols, alcohols, ketones, esters, hydrocarbons, halogenated hydrocarbons, polyvinyl chloride; in addition, solid carriers such as clays, cellulosic and rubber materials and synthetic polymers. The carrier or carrier material as used herein is defined as not including the body of an insect (e.g., Halyomorpha halys).

The amount of the composition for attracting Halyomorpha halys used will be at least an effective amount (i.e., 10 mg or more). The term “effective amount,” as used herein, means the minimum amount of the composition needed to attract Halyomorpha halys to a treated area or object or locus when compared to the same area or object or locus which is untreated. Of course, the precise amount needed will vary in accordance with the particular composition used; the type of area or object to be treated; the number of days of attractiveness needed; and the environment in which the area or object or locus is located. The precise amount of the composition can easily be determined by one skilled in the art given the teaching of this application. For example, one skilled in the art could follow the procedures utilized herein; the composition would be statistically significant in comparison to a control (e.g., water). Generally, the concentrations of synthetic chemicals discussed herein on rubber septa would range from about 10 mg to about 250 mg (e.g., 10 to 250 mg), monitoring traps would generally use about 50 mg while attract and kill may use about 250 mg, and release rates could generally be about 0.05 to about 1 mg (e.g., 0.05 to 1 mg) per septum per day. For example, the trap could contain 10 mg to 100 mg per trap of a composition comprising (i) (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, (ii) at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof; and (iii) optionally a carrier material or carrier.

The compositions described herein may or may not contain a control agent for Halyomorpha halys, such as a biological control agent or an insecticide known in the art to kill Halyomorpha halys. Other compounds may be added to the composition provided they do not substantially interfere with the intended activity of the composition; whether or not a compound interferes with attractant activity can be determined, for example, by the procedures utilized herein.

The attractant composition may contain the pheromone and the synergist in a mixed or otherwise combined form or it may contain the pheromone and the synergist independently in non-mixed form.

The attractant compositions may include one or more insecticides. In one embodiment, the insecticides are chemical insecticides known to one skilled in the art. Examples of the chemical insecticides include one or more of pyrethoroid or organophosphorus insecticides, including but are not limited to, cyfluthrin, permethrin, cypermethrin, bifinthrin, fenvalerate, flucythrinate, azinphosmethyl, methyl parathion, malathion, and sevin.

In another embodiment, the insecticides are one or more biological insecticides known to one skilled in the art. Examples of the biological insecticides include, but are not limited to, toxins from natural pyrethrins, Bacillus thuringiencis and Beauveria bassiana.

In certain embodiments, the attractant composition may include one or more polymeric agents known to one skilled in the art. The polymeric agents may control the rate of release of the composition to the environment. In some embodiments, the polymeric attractant composition is impervious to environmental conditions. The polymeric agent may also be a sustained-release agent that enables the composition to be released to the environment in a sustained manner.

Examples of polymeric agents include, but are not limited to, celluloses, proteins such as casein, fluorocarbon-based polymers, hydrogenated rosins, lignins, melamine, polyurethanes, vinyl polymers such as polyvinyl acetate (PVAC), polycarbonates, polyvinylidene dinitrile, polyamides, polyvinyl alcohol (PVA), polyamide-aldehyde, polyvinyl aldehyde, polyesters, polyvinyl chloride (PVC), polyethylenes, polystyrenes, polyvinylidene, silicones, and combinations thereof. Examples of celluloses include, but are not limited to, methylcellulose, ethyl cellulose, cellulose acetate, cellulose acetate-butyrate, cellulose acetate-propionate, cellulose propionate, and combinations thereof.

According to another embodiment of the disclosure, the attractant composition may include one or more insect feeding stimulants. Examples of insect feeding stimulants include, but are not limited to, crude cottonseed oil, fatty acid esters of phytol, fatty acid esters of geranyl geraniol, fatty acid esters of other plant alcohols, plant extracts, and combinations thereof.

According to another embodiment of the disclosure, the attractant composition may include one or more insect growth regulators (“IGRs”). IGRs may be used to alter the growth of the stink bugs and produce deformed stink bugs.

According to another embodiment of the disclosure, the attractant composition may include one or more insect sterilants that sterilize the trapped insects or otherwise block their reproductive capacity, thereby reducing the population in the following generation. In some situations, allowing the sterilized insects to survive and compete with non-trapped insects for a mate is more effective than killing them outright.

According to another embodiment of the disclosure, the attractant composition may include one or more additives that enhance the stability of the composition. Examples of additives include, but are not limited to, fatty acids and vegetable oils such as for example olive oil, soybean oil, corn oil, safflower oil, canola oil, and combinations thereof.

Furthermore, according to another embodiment of the disclosure, the attractant composition may include one or more fillers. Examples of fillers include, but are not limited to, one or more mineral clays (e.g., attapulgite). In some embodiments, the attractant composition may include one or more organic thickeners. Examples of such thickeners include, but are not limited to, methyl cellulose, ethyl cellulose, and any combinations thereof.

According to another embodiment, the attractant compositions of the present disclosure include one or more solvents. Compositions containing solvents are desirable when a user is to employ liquid compositions which may be applied by brushing, dipping, rolling, spraying, or otherwise applying the liquid compositions to substrates on which the user wishes to provide an insecticidal coating. In some embodiments, the solvent(s) to be used in the instant disclosure is/are selected so as to solubilize, or substantially solubilize, the one or more ingredients of the attractant composition. Examples of solvents include, but are not limited to, ethyl alcohol, methyl alcohol, chlorinated hydrocarbons, petroleum solvents, turpentine, xylene, and any combinations thereof.

According to another embodiment of the disclosure, the attractant composition may include one or more binders, such as synthetic and natural resins typically used in paints and coatings. These may be modified to cause the coated surface to be friable enough to allow insects to bit off and ingest the material, while still maintaining the structural integrity of the coating. In some embodiments, the binder also acts as a filler and/or a thickener. Examples of binders include, but are not limited to, one or more of shellac, acrylics, epoxies, alkyds, polyurethanes, linseed oil, tung oil, and any combinations thereof.

The attractant compositions of the disclosure may be used in traps, such as those commonly used to attract stink bugs. Such traps are well known to one skilled in the art, and are commonly used in many states and countries in their stink bug eradication programs. In one embodiment, the trap includes one or more septa, containers or storage receptacles for holding the attractant composition. In some embodiments, the pheromone traps containing the attractant composition may be combined with other kinds of trapping mechanisms. For example, in addition to the attractant composition, the pheromone trap may include one or more florescent lights, one or more sticky substrates and/or one or more colored surfaces for attracting stink bugs. In other embodiments, the pheromone trap containing the attractant composition may not have other kinds of trapping mechanisms.

A plurality of traps containing the attractant composition may be placed in a crop field. The locations of traps, and height of the traps from ground may be selected in accordance with methods known to one skilled in the art.

Insects in the Pentatomoidea superfamily include stink bugs and shield bugs. Stink bugs are in the Pentatomidae family. Any one or more of insects from the superfamily Pentatomoidea might be attracted to the disclosed compositions. Particularly, any one or more stink bugs disclosed herein may be attracted to the disclosed compositions. A variety of stink bugs are known in the art. Non-limiting examples of stink bugs include the green stink bug (Acrosternum hilare (Say)); several species of Euschistus spp. such as the brown stink bug (Euschistus servus (Say)), E. tristigmus, E. conspersus, E. variolarius, E. politus, or E. heros; the southern green stink bug (Nezara viridula (L.)); the eastern green stink bug (Nezara antennata); the spined soldier bug (Podisus maculiventris); the brown marmorated stink bug (Halyomorpha halys); the red-shouldered stink bug (Thyanta pallidovirens); the globular stink bug (Megacopta punctatissimum); the white-spotted stink bug (Eysarcoris ventralis); the fruit-piercing stink bug (Glaucias subpunctatus); the red-banded stink bug, Piezodorus guildinii; the red-striped stink bug (Graphosoma rubrolineatum); the East Asian stink bug (Halyomorpha mista); the rice stink bug (Lagynotomus elongates, Oebalus pugnax); the two-spotted stink bug (Perillus bioculatus); the conchuela stink bug (Chlorochroa ligata); Uhler's stink bug (Chlorochroa uhlerii); Say's stink bug (Chlorochroa sayi); the brown-winged green stink bug (Plautia stali (Scott)); the boxelder bug (Boisea trivittata (Say)); Banasa dimidiata (Say); B. calva (Say); B. euchlora Stal; the kudzu bug (Megacopta cribraria); and the Harlequin bug (Murgantia histrionica).

In particular, the attractant composition attracts stink bugs. In one embodiment, the attractant composition attracts insects of one or more species of the genus Euchistus. Examples of the Euchistus species include, but are not limited to, E. servus, E. tristigmus, E. conspersus, E. variolarius, E. politus, and E. heros. In a particular embodiment, the attractant composition attracts brown stink bugs, for example, E. servus. In a particular embodiment, the attractant composition attracts brown marmorated stink bugs, for example, Halyomorpha halys.

Compositions comprising a synergistic amount of murgantiol with at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof, may be used to attract nymphs and both sexes of adult stink bugs. In some embodiments, the stink bug is the brown marmorated stink bug.

The method of this disclosure involves attracting an insect belonging to the superfamily Pentatomoidea, and especially stink bugs such as the brown marmorated stink bug, to an outdoor predetermined location, comprising administering to the outdoor predetermined location a composition comprising one or more compounds that attract an insect from the superfamily Pentatomoidea (e.g., an alkyl or alkenyl ester of decadienoic acid or decatrienoic acid, and any stereoisomers thereof, and any combinations thereof) and a synergistic amount of murgantiol, wherein the composition is active in attracting the insect to the outdoor predetermined location. In some embodiments, the insect is a stink bug or shield bug. In some embodiments, the insect is an overwintered adult stink bug, a juvenile (nymph), or a new generation adult stink bug, including the brown marmorated stink bug. In some embodiments, the insect is from the genus Euschistus. In some embodiments, the insect is the brown marmorated stink bug.

In some embodiments, an attractant composition may comprise at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof; and murgantiol in a synergistic amount that significantly increases the attraction of the insect to the composition. The predetermined location may be a stink bug trap (e.g., an outdoor stink bug trap). Stink bug traps are further described herein. The composition may be comprised in a type of device(s) or dispenser(s) that controllably releases the composition. An attractant composition may further comprise an antioxidant or an oil, or a combination thereof, as described herein.

As described herein, populations of brown marmorated stink bugs can cause widespread damage to fruits, vegetables, and field crops including peaches, apples, green beans, soybeans, corn, tomatoes, cherries, raspberries, and pears. The brown marmorated stink bug is a sucking insect that uses its proboscis to pierce the host plant in order to feed. This feeding may cause necrotic areas on the outer surface of fruits, leaf stippling, cat-facing on tree fruits, seed loss, and transmission of plant pathogens. Frequently, brown marmorated stink bugs survive the winter indoors as adults by entering structures that shield them from the elements. Initially, they may go inside a structure, such as a house, to hibernate, but then become more animated due to the warmth of the structure. Adults typically begin overwintering at the end of September or early October and become a nuisance as large numbers congregate and invade buildings in search of overwintering sites. The indoor period is followed by an outdoor period. It is during the outdoor period that stink bugs, such as the brown marmorated stink bug, will feed and/or look for water/food and oviposition sites. It is during the outdoor period that the disclosed compositions are effective in controlling the insects by attracting the insects to the compositions, and particularly when the compositions are used in combination with traps.

The compositions of this disclosure may be disposed in any trap suitable for stink bug trapping outdoors when the stink bugs are experiencing their outdoor period. “Outdoors” includes any location where stink bugs in their “outdoor” period may be found, such as, but not limited to, fences, decks, vegetable gardens, fruit trees, ornamental trees, orchards, nurseries, agricultural crop fields, gardens, etc.

The disclosure also provides a method for attracting and trapping stink bugs. The method includes administering to a predetermined site an effective amount of the attractant composition. Such administering may be performed by adding the attractant composition to a septa or storage receptacle of a trap described herein. The trap may be set at any time of the year in a field. Those of skill in the art can readily determine an appropriate amount of the compositions to use in a particular trap, and can also determine an appropriate density of traps/acre of crop field to be protected.

In some embodiments, an outdoor stink bug trap includes one or more dispensers for holding and releasing compositions comprising murgantiol with at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof. Non-limiting examples of stink bug traps are described in U.S. Pat. No. 8,663,620; U.S. Pat. No. D645,534; U.S. Pat. No. D645,535; U.S. patent application Ser. No. 13/331,394, filed Dec. 20, 2011; U.S. Provisional Patent Application No. 61/477,044, filed Apr. 19, 2011, and U.S. Pat. No. 7,150,125, as well as Florida traps (see, e.g., Mizell and Tedders, Proc. Southeast Pecan Growers Assoc. 90:52 (1990)), wherein each reference is incorporated by reference in its entirety.

The method may include periodically monitoring the total number or quantity of the trapped insects. The monitoring may be performed by counting the number of insects trapped for a predetermined period of time such as, for example, daily, weekly, bi-weekly, monthly, once-in-three months, or any time period selected by the monitor. Such monitoring of the trapped insects may help estimate the population of insects for that particular period, and thereby help determine a particular type and/or dosage of pest control in an integrated pest management system. For example, when the number of trapped stink bugs is more than a pre-determined level in a particular week, a chemical pesticide may be sprayed or applied to a crop field in order to control stink bugs or a higher concentration of traps/acre may be set in a crop field in order to control stink bugs during that particular week.

In some embodiments, the method includes adding a pesticide to the trap so as to kill the trapped stink bugs. The pesticide may be a pesticide known to one skilled in the art. The pesticide may be mixed with the attractant composition or may be separately present in a trap. Mixtures may perform the dual function of attracting and killing the stink bugs.

The attractant composition may be used in the fields of any crop plants. Examples of such crop plants include, but are not limited to, cotton, soybeans, plums, pecans, peaches and okra.

The compositions may also be in a kit for attracting Halyomorpha halys. The kit may contain the pheromone (e.g., at least one of an alkyl or alkenyl ester of (2E,4Z)-decadienoic acid such as ethyl (2E,4Z)-decadienoate; an alkyl or alkenyl ester of (2Z,4E)-decadienoic acid such as ethyl (2Z,4E)-decadienoate; an alkyl or alkenyl ester of (2E,4E)-decadienoic acid such as ethyl (2E,4E)-decadienoate; an alkyl or alkenyl ester of (2E,4E,6Z)-decatrienoic acid such as ethyl (2E,4E,6Z)-decatrienoate; and any stereoisomers thereof, and any combinations thereof); and the synergist murgantiol; on a carrier. The kit may further contain an insect trap for housing the carrier. The kit may further contain written instructions directed to deploying the attractants at separate seasonal times. The kit may further contain one or more insecticides on the carrier.

A preferred embodiment is a composition comprising: a synergistic combination of (i) murgantiol and (ii) at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof. The C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof. The composition is a brown marmorated stink bug attractant. The composition can include murgantiol and ethyl (2E,4Z)-decadienoate or any stereoisomers thereof; murgantiol and ethyl (2E,4Z)-decadienoate; murgantiol and ethyl (2E,4E,6Z)-decatrienoate or any stereoisomers thereof; murgantiol and ethyl (2E,4E,6Z)-decatrienoate; or murgantiol, ethyl (2E,4Z)-decadienoate, and ethyl (2E,4E,6Z)-decatrienoate. The composition can further include an antioxidant, an oil, or any combination thereof.

Another preferred embodiment is a method of attracting a brown marmorated stink bug. The method involves: providing a trap comprising a composition described in paragraph [00201] above; and attracting the brown marmorated stink bug to the trap. The C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof. The brown marmorated stink bug is an adult brown marmorated stink bug or a nymph brown marmorated stink bug. The method further involves trapping the brown marmorated stink bug.

Yet another preferred embodiment is a method of attracting a brown marmorated stink bug. The method involves: providing an effective amount of the composition described in paragraph [00201] above to a predetermined location; and attracting the brown marmorated stink bug to the predetermined location. The C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof. The brown marmorated stink bug is an adult brown marmorated stink bug or a nymph brown marmorated stink bug. The method further involves trapping the brown marmorated stink bug. The predetermined location comprises crop fields, fences, decks, gardens, fruit trees, ornamental trees, orchards, or nurseries.

Still another preferred embodiment is a composition comprising: a synergistic combination of (i) geraniol and (ii) at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof. The C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof. The composition is a brown marmorated stink bug attractant. The composition includes geraniol and ethyl (2E,4Z)-decadienoate or any stereoisomers thereof; geraniol and ethyl (2E,4Z)-decadienoate; geraniol and ethyl (2E,4E,6Z)-decatrienoate or any stereoisomers thereof; geraniol and ethyl (2E,4E,6Z)-decatrienoate; or geraniol, ethyl (2E,4Z)-decadienoate, and ethyl (2E,4E,6Z)-decatrienoate. The composition further comprises an antioxidant, an oil, or any combination thereof.

Another preferred embodiment is a method of attracting a brown marmorated stink bug. The method involves: providing a trap comprising a composition described in paragraph [00204] above; and attracting the brown marmorated stink bug to the trap. The C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof. The brown marmorated stink bug is an adult brown marmorated stink bug or a nymph brown marmorated stink bug. The method further involves trapping the brown marmorated stink bug.

Yet another preferred embodiment is a method of attracting a brown marmorated stink bug. The method involves: providing an effective amount of the composition described in paragraph [00204] above to a predetermined location; and attracting the brown marmorated stink bug to the predetermined location. The C₂-C₁₀ alkyl or alkenylester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof. The brown marmorated stink bug is an adult brown marmorated stink bug or a nymph brown marmorated stink bug. The method further involves trapping the brown marmorated stink bug. The predetermined location comprises crop fields, fences, decks, gardens, fruit trees, ornamental trees, orchards, or nurseries.

Still another preferred embodiment is a composition comprising: at least one pheromone compound that attracts brown marmorated stink bugs; the at least one pheromone compound comprising murgantiol; and at least one synergist compound; the at least one synergist compound comprising a C₂-C₁₀ alkyl or alkenyl ester of decadienoic acid or a C₂-C₁₀ alkyl or alkenyl ester of decatrienoic acid, and any stereoisomers thereof. The at least one synergist compound comprises at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof. The C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof.

Another preferred embodiment is a composition comprising: at least one pheromone compound that attracts brown marmorated stink bugs; and at least one feeding attractant compound; the at least one feeding attractant compound comprising a C₂-C₁₀ alkyl or alkenyl ester of decadienoic acid or a C₂-C₁₀ alkyl or alkenyl ester of decatrienoic acid, and any stereoisomers thereof. The at least one feeding attractant compound comprises at least one of a C₂-C₁₀ alkyl or alkenyl ester of (2E,4Z)-decadienoic acid; a C2-C10 alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof. The C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof.

Yet another preferred embodiment is a composition comprising: (i) (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol; (ii) at least one of a C₂-C₁₀ of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof; and (iii) optionally a carrier material or carrier. The C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof. The composition further comprises (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, and (3S,6R,7R,10R)-10,11-epoxy-1-bisabolen-3-ol. The composition contains a 3:1 ratio of cis-epoxybisabolenols:trans-epoxybisabolenols produced from (R)-citronellal. The composition further comprises (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, and (3S,6S,7S,10R)-10,11-epoxy-1-bisabolen-3-ol. The composition further comprises, (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, and (3S,6R,7S,10S)-10,11-epoxy-1-bisabolen-3-ol. The composition further comprises (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, and (3S,6R,7S,10S)-10,11-epoxy-1-bisabolen-3-ol. The composition contains a 3:1 ratio of cis-epoxybisabolenols:trans-epoxybisabolenols produced from (S)-citronellal. The composition contains about 21% cis-epoxybisabolenols and about 41% trans-epoxybisabolenols. The composition further contains 1,2,10,11-diepoxybisabolan-3-ols. The composition contains about 37% 1,2,10,11-diepoxybisabolan-3-ols.

Still another preferred embodiment is a method for attracting Halyomorpha halys to an object or area. The method comprises treating the object or area with a Halyomorpha halys attracting composition comprising a Halyomorpha halys attracting effective amount of the composition described in paragraph [00209] above. The C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof.

Another preferred embodiment is a kit for attracting Halyomorpha halys. The kit includes: a first attractant comprising (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, on a first carrier, and a second attractant comprising at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof; on a second carrier or on the first carrier. The C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof. The kit further includes an insect trap for housing the first and second carriers. The kit further includes written instructions directed to deploying the attractants at separate seasonal times. The kit further includes one or more insecticides.

Yet another preferred embodiment is a composition comprising: (i) (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol; (ii) at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof, and any combinations thereof; and (iii) optionally a carrier material or carrier. The C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof. The composition further comprises (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, and (3S,6R,7S,10S)-10,11-epoxy-1-bisabolen-3-ol. The composition contains a 3:1 ratio of cis-epoxybisabolenols:trans-epoxybisabolenols produced from (S)-citronellal. The composition further comprises (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, and (3S,6S,7R,10R)-10,11-epoxy-1-bisabolen-3-ol. The composition further comprises (3R,6S,7R,10S)-10,11-epoxy-1-bisabolen-3-ol, (3R,6S,7R,10R)-10,11-epoxy-1-bisabolen-3-ol, (3S,6R,7R,10S)-10,11-epoxy-1-bisabolen-3-ol, and (3S,6R,7R,10R)-10,11-epoxy-1-bisabolen-3-ol. The composition contains a 3:1 ratio of cis-epoxybisabolenols:trans-epoxybisabolenols produced from (R)-citronellal.

Still another preferred embodiment is a method for attracting Halyomorpha halys to an object or area. The method involves treating the object or area with a Halyomorpha halys attracting composition comprising a Halyomorpha halys attracting effective amount of the composition described in paragraph [00212] above. The C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof.

Another preferred embodiment is a kit for attracting Halyomorpha halys. The kit includes: a first attractant comprising (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, on a first carrier, and a second attractant comprising at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof; on a second carrier or on the first carrier. The C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof. The kit further includes an insect trap for housing the first and second carriers. The kit further includes written instructions directed to deploying the attractants at separate seasonal times. The kit further includes one or more insecticides.

Yet another preferred embodiment is a composition comprising: (i) (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, (3R,6S,7R,10S)-10,11-epoxy-1-bisabolen-3-ol, (3R,65,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol; (ii) at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof; and (iii) optionally a carrier material or carrier. The C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof. The composition contains a 3:1 ratio of cis-epoxybisabolenols:trans-epoxybisabolenols produced from (R)-citronellal and the composition contains a 3:1 ratio of cis-epoxybisabolenols:trans-epoxybisabolenols produced from (S)-citronellal.

Still another preferred embodiment is a method for attracting Halyomorpha halys to an object or area, the method comprising treating the object or area with a Halyomorpha halys attracting composition comprising a Halyomorpha halys attracting effective amount of the composition described in paragraph [00215] above. The C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof.

Another preferred embodiment is a kit for attracting Halyomorpha halys. The kit includes: a first attractant comprising (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, (3S,6S,7R,10R)-10,11-epoxy-1-bisabolen-3-ol, (3R,6S,7R,10S)-10,11-epoxy-1-bisabolen-3-ol, (3R,65,7R,10R)-10,11-epoxy-1-bisabolen-3-ol, (3S,6R,7R,10S)-10,11-epoxy-1-bisabolen-3-ol, (3S,6R,7R,10R)-10,11-epoxy-1-bisabolen-3-ol, (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, (3S,6S,7S,10R)-10,11-epoxy-1-bisabolen-3-ol, (3R,6S,7S,10R)-10,11-epoxy-1-bisabolen-3-ol, (3S,6R,7S,10R)-10,11-epoxy-1-bisabolen-3-ol, (3R,6S,7S,10S)-10,11-epoxy-1-bisabolen-3-ol, (3S,6R,7S,10S)-10,11-epoxy-1-bisabolen-3-ol, on a first carrier, and a second attractant comprising at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof; on a second carrier or on the first carrier. The C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof. The kit further includes an insect trap for housing the first and second carriers. The kit further includes written instructions directed to deploying the attractants at separate seasonal times. The kit further includes one or more insecticides.

Yet another preferred embodiment is a composition comprising: (i) (3S,6S,7R,10S)-10,11-epoxy-1-bisabolen-3-ol; (ii) at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof; and (iii) optionally a carrier material or carrier.

Still another preferred embodiment is a composition comprising: (i) (3R,6S,7R,10S)-10,11-epoxy-1-bisabolen-3-ol; (ii) at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof; and (iii) optionally a carrier material or carrier.

Another preferred embodiment is a composition comprising: (i) (3S,6S,7R,10S)-10,11-epoxy-1-bisabolen-3-ol, (3R,6S,7R,10S)-10,11-epoxy-1-bisabolen-3-ol; (ii) at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof; and (iii) optionally a carrier material or carrier.

While we have shown and described several embodiments in accordance with our disclosure, it is to be clearly understood that the same may be susceptible to numerous changes apparent to one skilled in the art. Therefore, we do not wish to be limited to the details shown and described but intend to show all changes and modifications that come within the scope of the appended claims.

### Examples

Many aspects of insect behavior are mediated by olfactory signals. These olfactory signals are detected by sensory structures called sensilla which are innervated by olfactory receptor neurons and are located on various parts of the insect body including the antenna, mouthparts and tarsi. It is possible to determine the capabilities of the peripheral sensory system by using electrophysiology methods. Basically, extracellular neural responses from the individual receptor neurons located in the sensilla on the antenna of the stinkbug can be electrically recorded in response to stimulation with various concentrations of olfactory odorants.

Details of the recording methodology for insects have been described previously. Basically, the insect is immobilized and a recording microelectrode (electrolytically-sharpened tungsten wire) is inserted through the cuticle at the base of an individual sensillum. The action potentials within this sensillum can then be monitored and recorded. Microelectrodes are held in high gain, low drift micromanipulators for positioning. Electrical signals obtained from the neurons within the sensillum are band-passed filtered (300-3K Hz), amplified (1000×) and analyzed using commercial software, Autospike (Syntech, Hilversum, The Netherlands). The recording set-up is housed in a Faraday cage, and the electrical circuits required for this apparatus are isolated and independently earthed through a dedicated ground lead

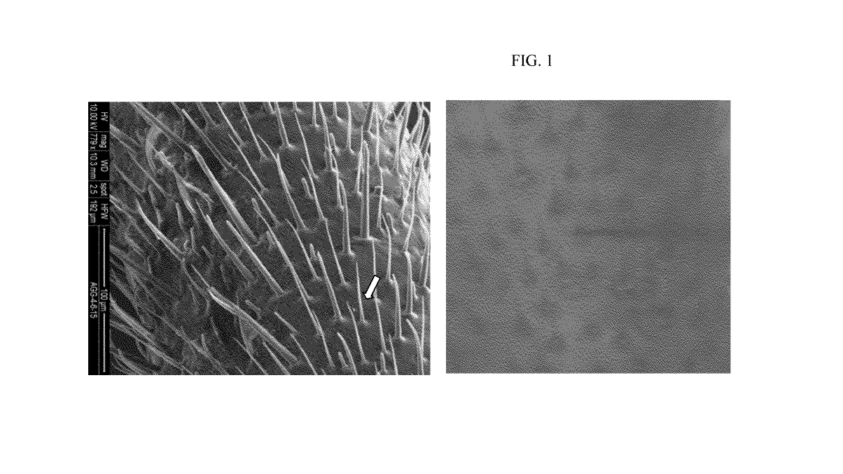

FIG. 1 contains two images. The image on the left is a scanning electron micrograph (SEM) depicting the sensilla field on the terminal segment of the brown marmorated stink bug antenna. The bar on the left of the image is 100 μm (microns=micrometers). The white arrow is pointing at one of the classes of sensilla from which recordings were made.

To obtain the SEM, insects are air-dried and affixed to a pin stub mount with double sides sticky tape (3M) and silver paint (Ladd Industries, Williston, Vt.). The pin stubs are then sputter-coated to a total thickness of 7-10 nm with gold-palladium and examined at an accelerating voltage of 5 kV with a FEI Quanta 200 FET MK II instrument at the University of Massachusetts Medical Center in Worcester, Mass. Images were digitally processed and stored.

In FIG. 1, the image on the right is taken through the electrophysiological setup microscope (AO spencer compound microscope) at approximately 500× (10× eyepiece; 50× Long Working Distance objective). The black structure coming in from the right of the image is the electrolytically etched tungsten recording electrode (10 mil diameter). The tip diameter of the etched electrode is between 1-2 μm.

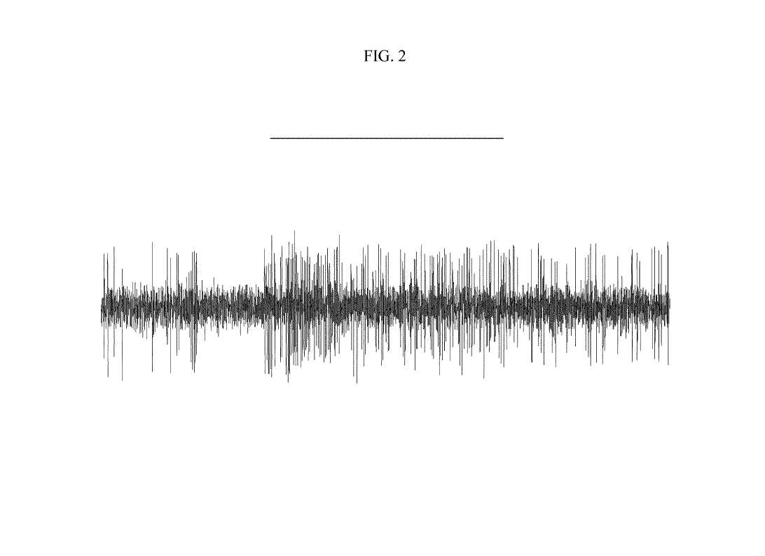

FIG. 2 represents an electrophysiological trace from an individual sensillum in response to an olfactory stimulus. The blue bar above the trace represents the 2 second stimulus period to ethyl (2E,4E,6Z)-decatrienoate. The stimulus dosage load is 100 μg diluted in ethanol. The dosage load does not represent the concentration of stimulant reaching the preparation but rather the amount dosed into the stimulus cartridge. To create the stimulus, 1 μl of an ethyl (2E,4E,6Z)-decatrienoate solution (100 μg/μl in ethanol) is pipetted onto a piece of filter paper held is a small glass cartridge. To deliver the stimulus, the contents of the cartridge is blown over the preparation in a stream of synthetic air (UltraZero; 0 ppm carbon dioxide).

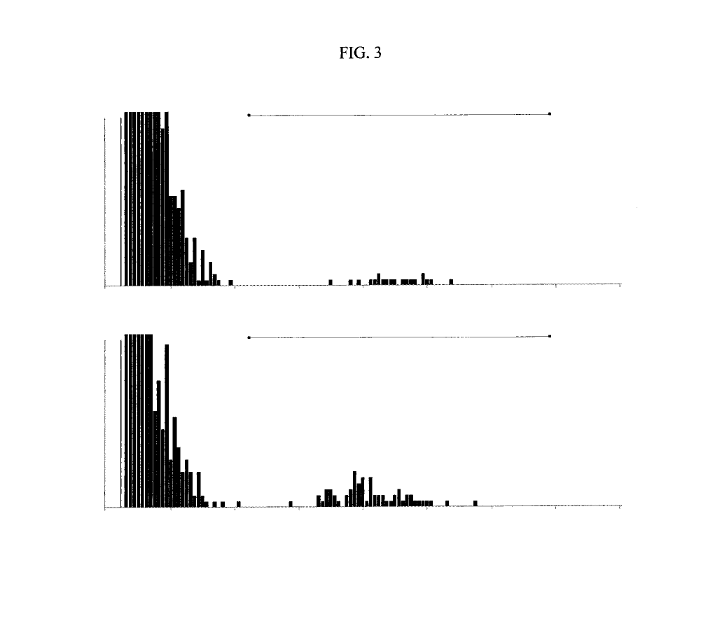

FIG. 3 represents screen shots of the analysis of the above trace (FIG. 2) from the software that used to analyze the electrophysiological data. The commercial available software is from Autospike (Syntech, Hilversum, The Netherlands). The top trace represents a 2 second control stimulus and the bottom trace represents the 2 second stimulus response to an 100 μg dosage stimulus of ethyl (2E,4E,6Z)-decatrienoate. In the histograms, each bar represents the number of impulses calculated for a metric of impulse size. As can be seen, there is more activity in the bottom stimulus histogram as compared to the top control histogram.

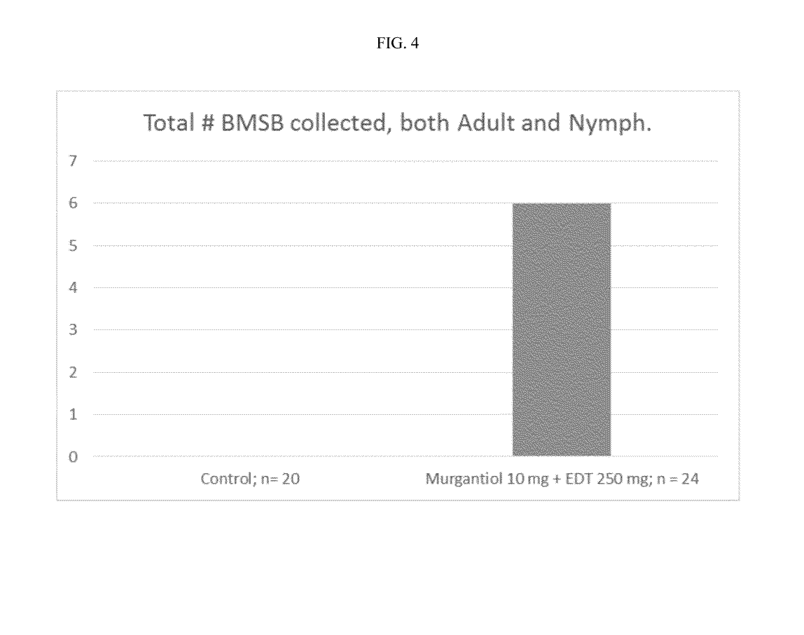

FIG. 4 graphically depicts attraction (total number of brown marmorated stink bug collected) of both adult and nymph brown marmorated stink bug with a control and a formulation containing murgantiol (10 mg) and ethyl (2E,4E,6Z)-decatrienoate (250 mg).

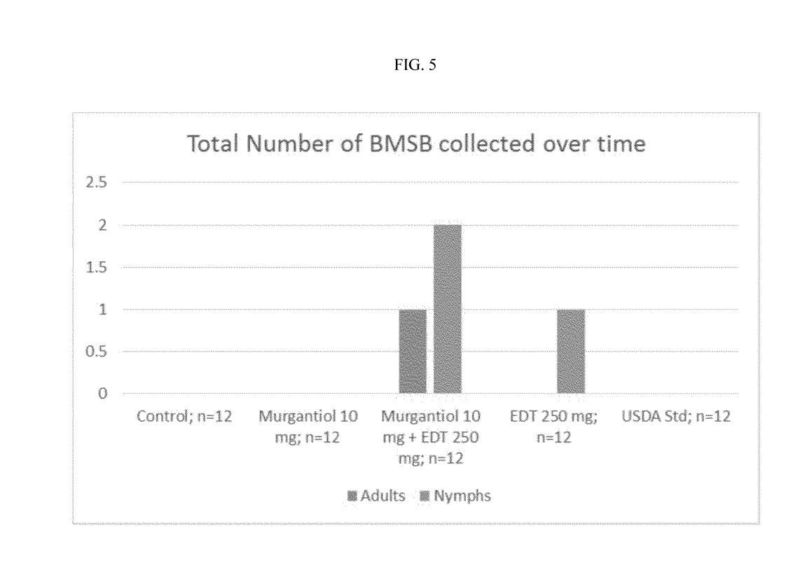

FIG. 5 graphically depicts attraction (total number of brown marmorated stink bug collected over time) of both adult and nymph brown marmorated stink bug with a control, murgantiol (10 mg), a formulation containing murgantiol (10 mg) and ethyl (2E,4E,6Z)-decatrienoate (250 mg), ethyl (2E,4E,6Z)-decatrienoate (250 mg), and a USDA standard.

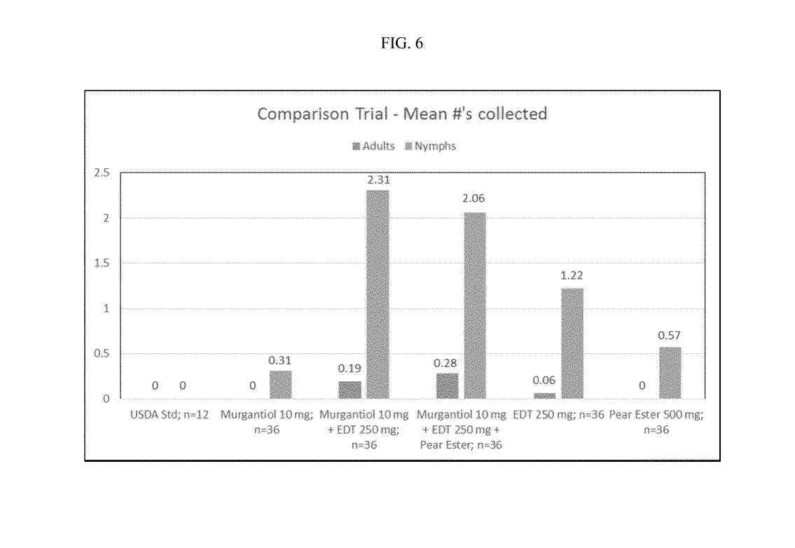

FIG. 6 graphically depicts attraction (mean numbers of brown marmorated stink bug collected over time) of both adult and nymph brown marmorated stink bug with a USDA standard, murgantiol (10 mg), a formulation containing murgantiol (10 mg) and ethyl (2E,4E,6Z)-decatrienoate (250 mg), a formulation containing murgantiol (10 mg), ethyl (2E,4E,6Z)-decatrienoate and pear ester (250 mg), ethyl (2E,4E,6Z)-decatrienoate (250 mg), and pear ester (500 mg). FIG. 6 shows that the formulations attracted higher mean numbers of both adult and nymphal brown marmorated stink bug, than any one material alone.

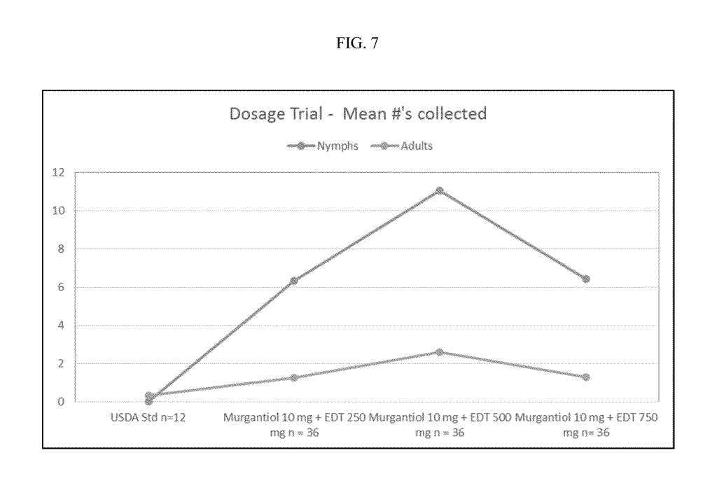

FIG. 7 graphically depicts attraction (mean numbers of brown marmorated stink bug collected over time based on dosage) of both adult and nymph brown marmorated stink bug with a USDA standard, a formulation containing murgantiol (10 mg) and ethyl (2E,4E,6Z)-decatrienoate (250 mg), a formulation containing murgantiol (10 mg) and ethyl (2E,4E,6Z)-decatrienoate (500 mg), and a formulation containing murgantiol (10 mg) and ethyl (2E,4E,6Z)-decatrienoate (750 mg). FIG. 7 shows that the optimal combination dose, that which attracted the highest number of both adult and nymphal brown marmorated stink bug, was murgantiol (10 mg) and ethyl (2E,4E,6Z)-decatrienoate (500 mg).

What is claimed is:

1. A composition comprising:
(a) a synergistic combination of (i) murgantiol and (ii) at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof; or
(b) a synergistic combination of (i) geraniol and (ii) at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof.

2. The composition of claim 1 wherein the C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof.

3. The composition of claim 1 which is a brown marmorated stink bug attractant.

4. The composition of claim 1 comprising:
(a) murgantiol and ethyl (2E,4Z)-decadienoate or any stereoisomers thereof; murgantiol and ethyl (2E,4Z)-decadienoate; murgantiol and ethyl (2E,4E,6Z)-decatrienoate or any stereoisomers thereof; murgantiol and ethyl (2E,4E,6Z)-decatrienoate; or murgantiol, ethyl (2E,4Z)-decadienoate, and ethyl (2E,4E,6Z)-decatrienoate; or
(b) geraniol and ethyl (2E,4Z)-decadienoate or any stereoisomers thereof; geraniol and ethyl (2E,4Z)-decadienoate; geraniol and ethyl (2E,4E,6Z)-decatrienoate or any stereoisomers thereof; geraniol and ethyl (2E,4E,6Z)-decatrienoate; or geraniol, ethyl (2E,4Z)-decadienoate, and ethyl (2E,4E,6Z)-decatrienoate

5. The composition of claim 1 further comprising an antioxidant, an oil, or any combination thereof.

6. A method of attracting a brown marmorated stink bug, said method comprising:
(i) providing a trap comprising a composition according to claim 1; and attracting the brown marmorated stink bug to the trap; or
(ii) providing an effective amount of the composition of claim 1 to a predetermined location; and attracting the brown marmorated stink bug to the predetermined location.

7. The method of claim 6 wherein the brown marmorated stink bug is an adult brown marmorated stink bug and/or a nymph brown marmorated stink bug.

8. The method of claim 6 wherein the predetermined location comprises crop fields, fences, decks, gardens, fruit trees, ornamental trees, orchards, or nurseries.

9. A composition comprising:
(a) at least one pheromone compound that attracts brown marmorated stink bugs; said at least one pheromone compound comprising murgantiol; and
at least one synergist compound; said at least one synergist compound comprising a C₂-C₁₀ alkyl or alkenyl ester of decadienoic acid or a C₂-C₁₀ alkyl or alkenyl ester of decatrienoic acid, and any stereoisomers thereof; or
(b) at least one pheromone compound that attracts brown marmorated stink bugs; and
at least one feeding attractant compound; said at least one feeding attractant compound comprising a C₂-C₁₀ alkyl or alkenyl ester of decadienoic acid or a C₂-C₁₀ alkyl or alkenyl ester of decatrienoic acid, and any stereoisomers thereof.

10. The composition of claim 9 wherein the at least one synergist compound or the at least one feeding attractant compound comprises at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof.

11. The composition of claim 10 wherein the C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof.

12. A composition comprising:
(a) (i) at least one of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, and (3S,6S,7R,10R)-10,11-epoxy-1-bisabolen-3-ol; (ii) at least one of a C₂-C₁₀ of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof; and (iii) optionally a carrier material or carrier; or
(b) (i) at least one of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, and (3S,6S,7S,10R)-10,11-epoxy-1-bisabolen-3-ol; (ii) at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof, and any combinations thereof; and (iii) optionally a carrier material or carrier.

13. The composition of claim 12 wherein the C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof.

14. A kit for attracting Halyomorpha halys, said kit comprising:
(a) a first attractant comprising at least one of (3R,6R,7R,10S)-10,11-epoxy-1-bisabolen-3-ol, (3R,6R,7R,10R)-10,11-epoxy-1-bisabolen-3-ol, (3S,6S,7R,10S)-10,11-epoxy-1-bisabolen-3-ol, and (3S,6S,7R,10R)-10,11-epoxy-1-bisabolen-3-ol, on a first carrier, and
a second attractant comprising at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof; on a second carrier or on said first carrier; or
(b) a first attractant comprising at least one of (3R,6R,7S,10S)-10,11-epoxy-1-bisabolen-3-ol, (3R,6R,7S,10R)-10,11-epoxy-1-bisabolen-3-ol, (3S,6S,7S,10S)-10,11-epoxy-1-bisabolen-3-ol, and (3S,6S,7S,10R)-10,11-epoxy-1-bisabolen-3-ol, on a first carrier, and
a second attractant comprising at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof; on a second carrier or on said first carrier.

15. The kit of claim 14 wherein the C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof.

16. The kit of claim 14 further comprising an insect trap for housing said first and second carriers.

17. The kit of claim 14 further comprising written instructions directed to deploying the attractants at separate seasonal times.

18. The kit of claim 14 further comprising one or more insecticides.

19. A composition comprising:
(a) (i) (3S,6S,7R,10S)-10,11-epoxy-1-bisabolen-3-ol; (ii) at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof; and (iii) optionally a carrier material or carrier; or
(b) (i) (3R,6S,7R,10S)-10,11-epoxy-1-bisabolen-3-ol; (ii) at least one of a C₂-C₁₀ alkyl or alkenyl ester of (2E,4Z)-decadienoic acid; a C₂-C₁₀ alkyl or alkenyl ester of (2Z,4E)-decadienoic acid; a C₂-C₁₀ alkyl or alkenyl ester of (2E,4E)-decadienoic acid; a C₂-C₁₀ alkyl or alkenyl ester of (2E,4E,6Z)-decatrienoic acid; and any stereoisomers thereof, and any combinations thereof; and (iii) optionally a carrier material or carrier.

20. The composition of claim 19 wherein the C₂-C₁₀ alkyl or alkenyl ester of (2E,4Z)-decadienoic acid comprises ethyl (2E,4Z)-decadienoate; the C₂-C₁₀ alkyl or alkenyl ester of (2Z,4E)-decadienoic acid comprises ethyl (2Z,4E)-decadienoate; the C₂-C₁₀ alkyl or alkenyl ester of (2E,4E)-decadienoic acid comprises ethyl (2E,4E)-decadienoate; the C₂-C₁₀ alkyl or alkenyl ester of (2E,4E,6Z)-decatrienoic acid comprises ethyl (2E,4E,6Z)-decatrienoate; and any stereoisomers thereof, and any combinations thereof.
